(19) United States
(12) Patent Application Publication
(10) Pub. No.: US 2008/0189171 A1
(43) Pub. Date: Aug. 7, 2008

(54) METHOD AND APPARATUS FOR CALL CATEGORIZATION

(75) Inventors: Moshe Wasserblat, Modiin (IL); Oren Pereg, Zikhron Ya'akov (IL); Tsvika Rabkin, Givataim (IL); Dvir Hofman, Kefar Saba (IL); Ilan Kor, Tel Mond (IL); Ilan Yossef, Pardesiya (IL)

Correspondence Address: SOROKER-AGMON ADVOCATE AND PATENT ATTORNEYS, NOLTON HOUSE, 14 SHENKAR STREET, HERZELIYA PITUACH, 46725, omitted

(73) Assignee: Nice Systems Ltd., Raanana (IL)

(21) Appl. No.: 11/669,955

(22) Filed: Feb. 1, 2007

(51) Int. Cl. G06F 11/34

(52) U.S. Cl. 705/11

(57) ABSTRACT

A method and apparatus for automated categorization of an interaction between a member of an organization and a second party. The method comprises defining one or more criteria and one or more categories, wherein each category relates to a combination of one or more criteria. The criteria involve data extracted from the interactions as well as external data. Each interaction is checked against the criteria, and is then assigned to one or more categories according to the met criteria. An optional evaluation of the categorization step, and improvement of the categorization if the evaluation results fall below a threshold are disclosed.

### BACKGROUND OF THE INVENTION

1. Field of the Invention

The present invention relates to a method and apparatus for categorization of interactions in general, and to categorization of interactions between customers and service centers in particular.

2. Discussion of the Related Art

Within organizations or organizations' units that mainly handle interactions, such as call centers, customer relations centers, trade floors, law enforcements agencies, homeland security offices or the like, it is often valuable to classify interactions according to one or more anthologies. Interactions may be of various types, including phone calls using all types of phone, transmitted radio, recorded audio events, walk-in center events, video conferences, e-mails, chats, access through a web site or the like. The categories may relate to various aspects, such as content of the interactions, entities classification, customer satisfaction, subject, product, interaction type, up-sale opportunities, detecting high-risk calls, detecting legal threats, customer churn analysis or others. Having structured information related to the interaction, including a category associated with an interaction may be important for answering questions, such as what is the general content of the interaction, why are customers calling, what are the main contributions to call volume, how can the volume be reduced and others. The categorization can also be used for taking business actions, such as locating missed opportunities, locating dissatisfied customers, more accurate resource allocation, such as allocating more agents to handle calls related to one or more subjects of business process optimization, cost reduction, improving quality/service/product, agent tutoring, preventing customer churn and the like.

However, current categorization techniques rely heavily on manpower to perform the task. This has a number of drawbacks: the categorization task is time consuming, and is therefore subject to be done off-handedly. Alternatively, if categorizing a call is not done immediately once a call has ended, immediate or fast action, including a corrective action becomes irrelevant. Due to the time consumption, rarely do categorizers receive feedback for their work, and thus do not learn from mistakes. In addition, human categorization may be subjective—different personnel members may emphasize different aspects of an interaction; an interaction may be related to more than one subject, in which case different humans may assign it to different subjects. In addition, a person categorizing a call might not take into account all information and data item available for the call, whether due to negligence, information overload, lack of time or the like.

There is therefore a need for an automated system and method for categorizing interactions within an organization. The system and method should be efficient, to enable categorization for a large volume of interactions, and achieve results in real-time or shortly after an interaction has ended. The system and method should enable an interaction to be categorized into multiple categories related to various aspects, and possibly to hierarchically organized categories. It is also desired that categorization may relate to only a specific part of an interaction. The system and method should take into account all relevant data and information available for the call, and should enable a feedback mechanism in which information gathered from other sources may be used to enhance and fine-tune the performance of the system.

### SUMMARY OF THE PRESENT INVENTION

It is an object of the present invention to provide a novel method and apparatus for categorization of interactions in an organization, which overcomes the disadvantages of the prior art. In accordance with the present invention, there is thus provided a method for automated categorization of one or more interactions, the method comprising: a criteria definition step for defining one or more criteria associated with one or more information items; a category definition step for defining one or more categories associated with one or more aspects of the organization; an association step for associating the one or more criteria with one or more categories; a receiving step for receiving one or more information items related to the interactions; a criteria checking step for determining whether tone or more criteria are met for the interactions; and a categorization step for determining an interaction category relevancy for one or more parts of the interactions and the categories. The method optionally comprises a capturing step for capturing the interactions. Within the method, the interaction can comprise a vocal component. The method optionally comprises an interaction analysis step for extracting the information items from the interactions. The analysis step optionally comprises one or more analyses selected from the group consisting of: word spotting; transcription; emotion detection; call flow analysis; or analyzing one or more relevant information items. The relevant information items are optionally selected from the group consisting of: customer satisfaction score; screen event; third party system data; Computer-Telephony-Integration data; Interactive Voice Response data; Business data; video data; surveys; customer input; customer feedback; or a combination thereof. Within the method, the analysis step is optionally multi-phase conditional analysis between two or more analyses. The analysis is optionally time-sequence related. The information item can be selected from the group consisting of: customer satisfaction score; screen event; third party system data; Computer-Telephony-Integration data; Interactive Voice Response data; Business data; video data; surveys; customer input; customer feedback; or a combination thereof. One or more criteria are optionally temporal criteria. The method optionally comprises a notification step. The notification step optionally comprises one or more of the group consisting of: generating a report; firing an alert; sending a mail; sending an e-mail; sending a fax; sending a text message; sending a multi-media message; or updating a predictive dialer. The method can further comprise a categorization evaluation step for evaluating a performance factor associated with the categorization step according to an at least one external indication. The external indication is optionally any one or more or the group consisting of: customer satisfaction score; user evaluation; market analysis evaluation; customer behavioral analysis; agent behavioral analysis; business process optimization analysis; new business opportunities analysis; customer churn analysis; or agent attrition analysis. Within the method the criteria optionally relates to spotting at least a first predetermined number of words out of a predetermined word list. Within the method, one or more categories can be associated with two or more criteria. The two or more criteria are optionally connected through one or more operators. The operators are optionally selected from the group consisting of: “and”; “or”; or “not”. Within the method, the interaction category relevancy is optionally a prediction of customer satisfaction score. Within the method, the category definition step is optionally performed manually or automatically. The category definition step optionally uses clustering or is semi-automated. The method optionally comprises a categorization update step. The categorization update step is optionally performed by providing feedback or by tuning the one or more categories. Within the method, the one or more categories are optionally constructed using a self learning process.

Another aspect of the disclosed invention relates to an apparatus for automated categorization of one or more interactions between a member of an organization and a second party, the apparatus comprising: a criteria definition component for defining one or more criteria associated with one or more information items; a category definition component for defining one or more categories associated with an one or more aspects of the organization; an association component for associating the criteria with the categories; a criteria checking component for checking according to one or more information items associated with the interactions whether one or more of the criteria are met for the interactions; and a category checking component for determining one or more scores for assigning one or more parts of the interactions to the categories. The apparatus can further comprise one or more analysis engines for extracting the information items. The analysis engines are optionally selected from the group consisting of: word spotting; transcription; emotion detection; call flow analysis or analyzing a relevant information item. The apparatus optionally comprises a playback component for reviewing the interactions and a category indication. The apparatus can further comprise a storage and retrieval component for storing the scores, or a storage and retrieval component for retrieving necessary data sources. The apparatus optionally comprises a categorization evaluating component for evaluating one or more performance factors associated with the scores. The apparatus can further comprise a categorization improvement component for enhancing the categories or the criteria.

Yet another aspect of the disclosed invention relates to a computer readable storage medium containing a set of instructions for a general purpose computer, the set of instructions comprising: a criteria definition component for defining one or more criteria associated with one or more information items; a category definition component for defining one or more categories associated with one or more aspects of the organization; an association component for associating the criteria with the categories; a criteria checking component for checking according to one or more information items associated with the interactions whether a criteria is met for an interaction; and a category checking component for determining one or more scores for assigning one or more parts of the interactions to any of the categories.

### BRIEF DESCRIPTION OF THE DRAWINGS

The present invention will be understood and appreciated more fully from the following detailed description taken in conjunction with the drawings in which:

FIG. 1 is a block diagram of the main components in a typical environment in which the disclosed invention is used;

FIG. 2 is a flowchart of the main steps in the training phase of an automatic categorization method, in accordance with a preferred embodiment of the disclosed invention;

FIG. 3 is a flowchart of the main steps in a method for categorizing an interaction, in accordance with a preferred embodiment of the disclosed invention;

FIG. 4 is an example for defining criteria, in accordance with a preferred embodiment of the disclosed invention;

FIG. 5 is an XML listing of a collection of categories, in accordance with a preferred embodiment of the disclosed invention,

FIG. 6 is a an illustration of a playback screen, showing categories associated with an interaction, in accordance with a preferred embodiment of the disclosed invention; and

FIG. 7 is a block diagram of the main components in an apparatus according to the disclosed invention.

### DETAILED DESCRIPTION OF THE PREFERRED EMBODIMENT

The present invention overcomes the disadvantages of the prior art by providing a novel method and apparatus for interaction categorization.

The present invention provides a mechanism for categorizing interactions within an organization, using multi-dimensional analysis, such as content base analysis and additional data analysis. An organization or a relevant part of an organization is a unit that receives and/or initiates multiple interactions with other parties, such as customers, suppliers, other organization members, employees and other business partners. The interactions preferably comprise a vocal component, such as a telephone conversation, a video conference having an audio part, or the like. Additional data is preferably available as well for the interaction, such as screen data, content extracted from the screen, screen events, third party information related to one or more participants of the call, a written summary by a personnel member participating in the call, or the like. The categorization invention preferably uses two stages. Categories are defined to reflect business needs of the organization, such as customer satisfaction level, subject, product or others. Each category preferably involves one or more interrelated criteria including words to be spotted, emotion level and others. However, the categorization does not mandate defining words as a baseline for action but can rather employ self unsupervised learning. In a first stage, criteria and a collection of categories for the environment, and a combination of criteria are assigned for each category, so that an interaction meeting the criteria is assigned to the category. At a second stage, captured or stored interactions are checked against the criteria, and each interaction is optionally assigned to one or more categories. Alternatively, each interaction is optionally assigned a score denoting for each category to what degree the interaction is associated with the category. The categories may relate to the whole environment or to a part thereof, such as a specific customer service department. The assignment of an interaction to a category relates to the whole interaction, or to a part thereof. The criteria assigned to each category preferably relates to data retrieved from the vocal part of an interaction, including speech to text analysis, spotted words, phonetic search, emotion detection, call flow analysis, or the like. When video information is available for the interaction, video analysis tools are preferably used too, such as face recognition, background analysis or other elements that can be retrieved from a video stream. The criteria for assigning an interaction to a category preferably relates also to data collected from additional sources, such as screen events, screen data that occurred on the display of an agent handling an interaction, third party information related to the call, the customer, or the like. Further available data may relate to meta data associated with the interaction, such as called number, calling number, time, duration or the like. In certain cases, a customer satisfaction level as reported by a customer taking an Interactive Voice Response (IVR) survey is also considered as part of the criteria. Preferably, criteria combinations are applied to the interactions, such as and/or, out-of, at-least criteria or others, so that an interaction is assigned to a category if it fulfills one or more combined criteria associated with the category. Alternatively, the assignment of a category to an interaction is not boolean but quantitative. Thus, each interaction is assigned a degree denoting to which extent it should be assigned to a certain category. The system and method preferably further provide a feedback mechanism, in which a user-supplied categorization, or another type of indication is compared against the performance of the system, and is used for enhancement and improvement of the criteria and category definition. Both the initial construction of the criteria and categories, and the enhancement can be either performed manually by a person defining the criteria; automatically by the system using techniques such as pattern recognition, fuzzy logic, artificial neural networks, clustering or other artificial intelligence techniques to deduce the criteria from given assignment of interactions into categories; or in a semi-automated manner using a combination thereof. For example, an initial definition of a category is performed by a person, followed by automatic classification of calls by the system, further followed by the user enhancing the categorization by fine-tuning a category. Additionally, after calls are manually classified by a user, the system optionally deploys a self learning and adaptation process involving clustering the manually classified interaction to recognize patterns typical to a category, and modify the category definition. The combination of automatic categorization, together with clustering and pattern recognition performed on manually classified calls, enhances the accuracy of the categorization.

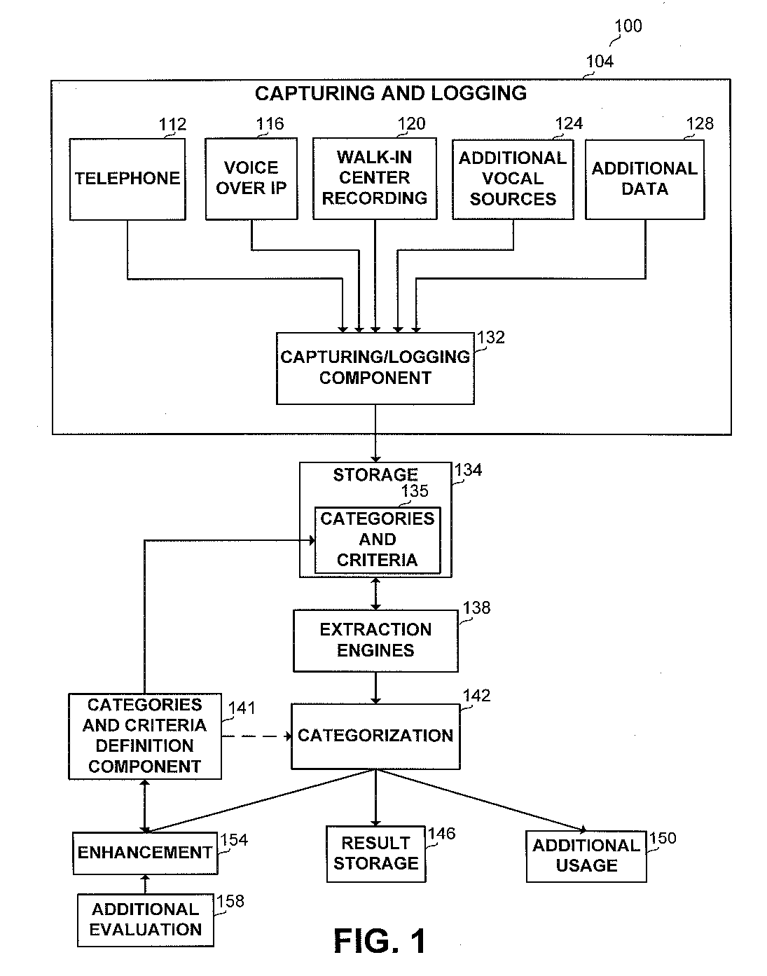

Referring now to FIG. 1, showing a block diagram of the main components in a typical environment in which the disclosed invention is used. The environment, generally referenced as 100, is an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Interactions with customers, users, organization members, suppliers or other parties are captured, thus generating input information of various types. The information types optionally include vocal interactions, non-vocal interactions and additional data. The capturing of voice interactions can employ many forms and technologies, including trunk side, extension side, summed audio, separate audio, various encoding and decoding protocols such as G729, G726, G723.1, and the like. The vocal interactions usually include telephone 112, which is currently the main channel for communicating with users in many organizations. The voice typically passes through a PABX (not shown), which in addition to the voice of the two or more sides participating in the interaction collects additional information discussed below. A typical environment can further comprise voice over IP channels 116, which possibly pass through a voice over IP server (not shown). The interactions can further include face-to-face interactions, such as those recorded in a walk-in-center 120, and additional sources of vocal data 124, such as microphone, intercom, the audio part of video capturing, vocal input by external systems or any other source. In addition, the environment comprises additional non-vocal data of various types 128. For example, Computer Telephony Integration (CTI) used in capturing the telephone calls, can track and provide data such as number and length of hold periods, transfer events, number called, number called from, DNIS, VDN, ANI, or the like. Additional data can arrive from external or third party sources such as billing, CRM, or screen events, including text entered by a call representative during or following the interaction, documents and the like. The data can include links to additional interactions in which one of the speakers in the current interaction participated. Data from all the above-mentioned sources and others is captured and preferably logged by capturing/logging unit 132. Capturing/logging unit 132 comprises a computing platform running one or more computer applications as is detailed below. The captured data is optionally stored in storage 134 which is preferably a mass storage device, for example an optical storage device such as a CD, a DVD, or a laser disk; a magnetic storage device such as a tape or a hard disk; a semiconductor storage device such as Flash device, memory stick, or the like. The storage can be common or separate for different types of captured interactions and different types of additional data. The storage can be located onsite where the interactions are captured, or in a remote location. The capturing or the storage components can serve one or more sites of a multi-site organization. Storage 134 further stores the definition of the relevant categories and the criteria applied for determining whether or to what degree an interaction should be assigned to one or more categories. Storage 134 can comprise a single storage device or a combination of multiple devices. Categories and criteria definition component 141 is used by the person in charge of defining the categories, for defining the categories, possibly in a hierarchic manner, and the criteria which an interaction has to fulfill in order to be assigned to a category. The system further comprises extraction engines 138, for extracting data from the interactions. Extraction engines 138 may comprise for example a word spotting engine, a speech to text engine, an emotion detection engine, a call flow analysis engine, and other tools for retrieving data from voice. Extraction engines may further comprise engines for retrieving data from video, such as face recognition, motion analysis or others. Categorization component 142 receives the information and features extracted from the interactions, statistical evaluation of previous data stored and categorization models, and applies the criteria in order to evaluate whether a certain interaction fits to a certain category, or to what extent the interaction fits to the category. The categorization results are sent to result storage device 146, and to additional components 150, if required. Such components may include playback components report-generating components, alert generation components, notification components such as components for sending an e-mail message, a fax, a text message, a multi media message or any other notification sent to a user. The message optionally comprises the interaction itself, information related to the interaction, or just a notification. The categorization results are optionally sent also to enhancement component 154, which receives additional evaluations 158. The additional evaluations can be, for example a manual evaluation performed for the same interactions, a customer feedback, or any other relevant evaluation. Enhancement component 154 tests the performance of the system, i.e. the categorization results, against the additional evaluation, and preferably enhances the categories and/or the criteria. The enhancement can be done by a human evaluator, machine learning or a combination thereof. All components of the system, including capturing/logging components 132 extraction engines 138 and categorization component 142 are preferably collection of instruction codes designed to run on a computing platform, such as a personal computer, a mainframe computer, or any other type of computing platform that is provisioned with a memory device (not shown), a CPU or microprocessor device, and several I/O ports (not shown). Alternatively, each component can be a DSP chip, an ASIC device storing the commands and data necessary to execute the methods of the present invention, or the like. Each component can further include a storage device (not shown), storing the relevant applications and data required for processing. Each software component or application running on each computing platform, such as the capturing applications or the categorization component is a set of logically inter-related computer instructions, programs, modules, or other units and associated data structures that interact to perform one or more specific tasks. All applications and software components can be co-located and run on the same one or more computing platform, or on different platforms. In yet another alternative, the information sources and capturing platforms can be located on each site of a multi-site organization, and one or more application components can be remotely located, categorize interactions captured at one or more sites and store the categorization results in a local, central, distributed or any other storage.

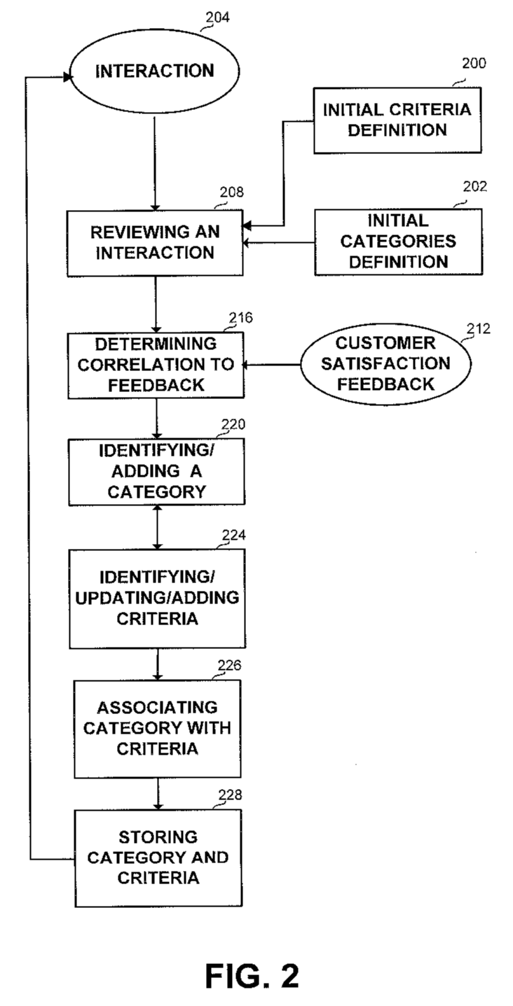

Referring now to FIG. 2, showing a preferred embodiment of the main steps in the training phase, in accordance with the disclosed invention. Step 200 is an optional step in which initial criteria are defined for interactions, including information items such as words or word combinations to be spotted, emotional levels to be detected, customer satisfaction scores to be met or the like. An additional criteria type relates to spotting at least a predetermined number of words out of a predetermined word list. For example, if the organization wishes to detect a customer closing his or her account, the list may comprise the words “close”, “cancel”, “cancel account”, “close account”, “close my account”, etc. A criterion may relate to detecting at least one of this list. Step 200 can be omitted, and criteria can be defined later on demand per a category or per an interaction. Step 202 is also an optional step in which initial categories are defined, which relate to one or more aspect of the organization. This step can be performed when the user, i.e. the person or persons building the categorization are aware of at least the main categories to which interactions are to be assigned. For example, when the categories refer to customer satisfaction, the predetermined top level categories can be “good interactions” and “bad interactions”, or “satisfactory interactions” and “dissatisfactory interactions”. Alternatively, the categories can refer to various products such as “product X”, “product Y”, etc., to the type of the call, such as “service”, “purchase”, “inquiry” or the like. The categories can overlap, and are not necessarily complementary. Thus, an interaction can be assigned to both a category of “good interaction”, and to a category named “product X”. Step 202 can be omitted and the categories can be defined when relevant interactions are encountered, as detailed below. If criteria are available at category definition step 202, one or more criteria can be associated with the category, with relations including “and”, “or”, “not” or a combination thereof. In the example mentioned above, an organization may wish to detect one of the mentioned phrases, together with an emotional level exceeding a predetermined level. An Interaction 204 is reviewed by the user, i.e. the person constructing the categorization in step 208. The reviewing comprises of all relevant information, such as listening to a vocal interaction, watching a visual interaction, receiving relevant information such as Computer-Telephony-Integration (CTI) data, reading text entered by a participant of the call or a previous evaluator, or the like. In a preferred embodiment of the disclosed invention, a customer satisfaction feedback 212 is available for the interaction. The feedback can be obtained from a post call survey using Interactive voice response (IVR), e-mail, mail survey, or any other method for obtaining direct feedback from the customer. If feedback 212 is available, the user determines at step 216 the correlation between the interaction and the feedback. If the correlation is low, the interaction may be disqualified from being part of the training session, or the user may change his or her mind about the interaction, and how to categorize it. Alternatively, the low correlation can be subject to further analysis for surfacing new elements that should be detected, such as words to be spotted, call flow situations to be identified, or the like. Methods of extracting new elements that can provide root cause for low correlation can be but are not limited to clustering, fuzzy logic, or the like. The user feedback is optionally used as an additional factor in the total scoring. In a preferred embodiment, the feedback may be further used as an input to a self-learning mechanism for extracting unique patterns that characterize “good” or “bad” interactions. Step 216 is especially relevant for cases involving for example customer satisfaction level categories wherein the customer's evaluation is the most informative tool. At step 220 the user identifies which of the existing categories the interaction best matches, or if the interaction can not be satisfactorily assigned to an existing category, a new category is defined. A new category may be a sub-category of one or more existing categories, or an independent category. At step 224 the user determines which one or more of the criteria are applicable for the category for the specific interaction. Such criteria may exist, for example, the interaction contains two or more words from a predetermined list, wherein a criterion requires at least one word of the list to appear in an interaction in order for the interaction to be associated with a specific category. If no criteria is suitable, an existing criteria is updated, for example by adding words to lists, constructing new lists, defining conditions relevant to emotion level, call flow analysis or others. Alternatively, a new criterion is generated and associated with the relevant category. A new criterion may also be generated out of the interaction or category scope, i.e. for later usage. Thus, steps 220 and 224 do not have an obliging order, and any criteria or any category can be defined. A new criterion can be defined independently or as part of defining a category, and the criteria associated with a category may change. Customer satisfaction feedback 212, if available, can be used for defining/updating categories, or for defining/updating criteria to take into account customer feedback when available. On step 226 the identified/updated/newly created criterion is optionally associated with a category, and at step 228, the generated or updated categories and criteria are stored. Alternatively, each newly created category or criterion can be stored upon creation or update. The process, excluding the initial definition the categories or criteria, repeats for all available interactions. As a general rule, the more interactions the categorization is based on, the more representative the results. However, processing a large number of interactions is time consuming, so the process sometimes provides sub-optimal results due to time constraints of the user. In another preferred embodiment, the training phase can be performed without reviewing any interactions, and by only defining criteria, categories, and the connections between them. This embodiment can be used for fast construction of an initial categorization, which can be later updated based on captured interactions, customer feedback, and user feedback, in a self learning process or a manual based process.

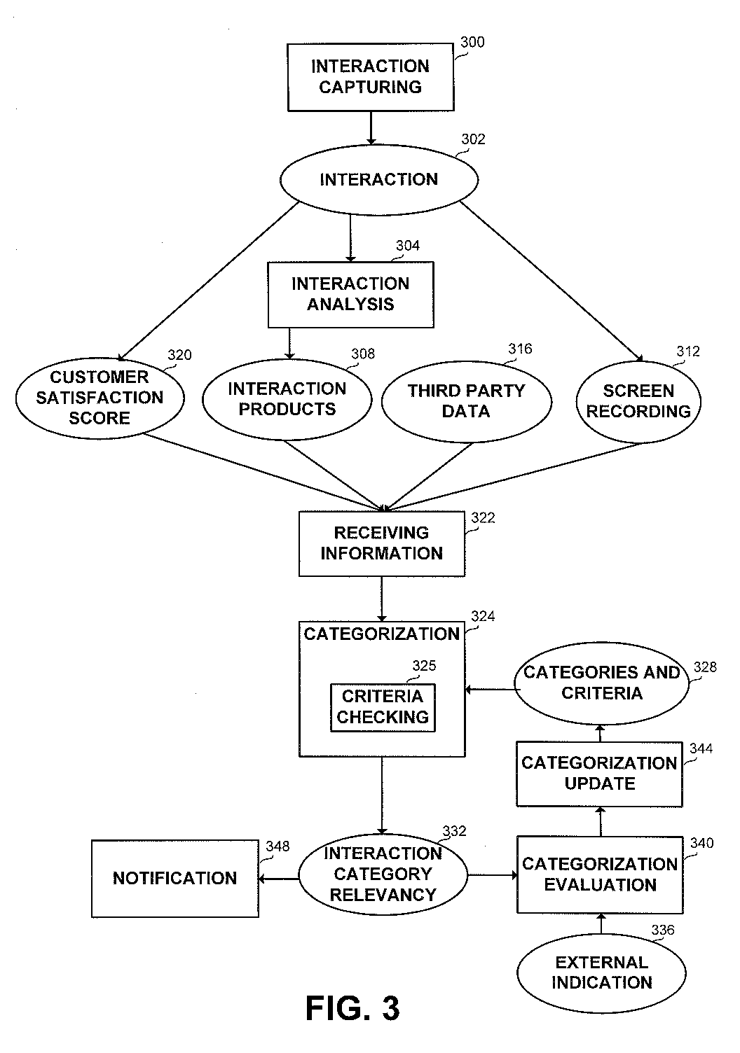

Referring now to FIG. 3, showing a preferred embodiment of the main steps in the actual categorization phase, in accordance with the disclosed invention. Interaction capturing step 300 captures an interaction 302 which is introduced to a system according to the disclosed invention. The interaction can be introduced online. i.e., while the interaction is still in progress, near-online, i.e., a short time in the order of magnitude of seconds or minutes after the interaction ended, or off-line, as retrieved from a storage device. At step 304 the interaction is processed by analysis engines. The analysis comprises any component of the interaction that can be analyzed. For example, the vocal part of an interaction is analyzed using voice analysis tools. The analysis preferably includes any one or more of the following: spotted words, i.e., spotting words from a predetermined list within the interaction; speech to text analysis, i.e. generating a full transcription of the vocal part of the interaction; emotion analysis call flow analysis; phonetic search of one or more phrases, or the like. The products of the analysis are interaction products 308, which include for example spotted words, together with their relative timing within the interaction, and additional parameters such as certainty accuracy, emotion levels within the interaction, together with relative time indication, call flow analysis with time indications, or the like. Interaction products 308 are input to receiving step 322, which receives information items associated with the interaction. Additional input to receiving step 322 is screen recording 312. Screen recording 312 preferably comprises the events that occurred on the screen of the computing platform used by the person handling the interaction, during the interaction. Such events can include choices made among options (such as a product chosen from a product list), free text entered by the person, and additional details. Further input to receiving step 322 is third party data 316. Data 316 can comprise data from systems such as customer relationship management (CRM), billing, workflow management (WFM), the corporate Intranet, mail servers, the Internet, relevant information exchanged between the parties before, during or after the interaction, and others. Yet another input to receiving step 322 is customer satisfaction score 320, if one exists. Score 320 is particularly useful if the categorization includes categories related to customer satisfaction, i.e. if one or more criteria are designed to take this parameter into account. Categorization step 324 uses categories and criteria 328 as generated in the training phase, and checks for each category whether interaction 302 can be assigned to the category. The checking is based on the information received in step 322. As an optional step, categorization step 324 comprises a criteria checking step 325 for checking all criteria against the interaction, and determining which criteria are met for the specific interaction. Then, the assignment of an interaction into one or more categories depends on the met criteria. However, the criteria checking can be performed for each category separately and not for all criteria at once before any category is checked. A particular category might be reached through one or more criteria (for example, a “dissatisfied customer” category may be reached through spotting angry words, or through detecting high emotion level; alternatively, a single rule may be defined, comprising the two mentioned conditions, with OR relationship between them). Thus, the method can be designed to stop checking a particular category once an interaction was assigned to that category, i.e. one criterion was met. Alternatively, the method can check further rules for the particular category, and optionally combine their results. Such combination can comprise simply the number of criteria met, or if a score is assigned for each criteria, a combination such as a sum, average or another operation on the separate scores. The output of categorization step 324 is interaction category relevancy 332, denoting for each interaction 302 its relevancy for one or more specific categories, either in a yes/no form or in a numeric form. If the aspect which the categorization relates to is customer satisfaction, the output of categorization step 324 is an indication or a prediction to customer satisfaction score. Alternatively, interaction category relevancy 332 relates to a part of the interaction, according to where in the interaction the criteria were met. In such case, interaction category relevancy 332 carries also an indication location within the interaction. When categories are defined in a hierarchical manner, when an interaction is assigned to a particular category, it is an option to skip the check whether the interaction can be assigned to subcategories. For example, if an interaction is not assigned to a category of “dissatisfactory interactions”, there is often no point in checking whether it can be assigned to a subcategory “dissatisfactory interactions, impolite agent”. However, this is not an inherent limitation, and the method can be designed to do perform further checks. In a similar manner, the method can check or avoid checking further top-level categories once an interaction was assigned to one top-level category. Interaction category relevancy 332 is an input to optional notification step 348. Notification step 348 comprises notifying one or more users about an interaction relevancy. The notification can take place for all results, for results exceeding a predetermined threshold wherein the threshold can be specific for each category, for relevancy results related only to one or more categories, or the like. The notification can take any required form or forms, including updating a database, firing an alert, generating a report, sending a mail, an e-mail, a fax, a text message, a multimedia message, updating a predictive dialer (a predictive dialer is a module which generates outgoing calls, typically to customers, and connect the called person to an agent once the call is answered), for example with new customer numbers, new destination agents, or the like. An optional further step is categorization evaluation step 340, designed for evaluating one or more performance factors of the categorization process, such as hit ratio per category i.e. the percentage out of all interactions that should be assigned to a specific category that are indeed classified to the category, false alarm rate i.e. the percentage of all interactions assigned to a category that should not have been assigned to the category, and others. Categorization evaluation step 340 receives as input the collection of call category relevancy 332, and an external indication 336, such as user/customer evaluation. When external indication 336 is user evaluation, the input is a feedback score assigned to an interaction by a customer, similarly to customer satisfaction feedback 212 of FIG. 2. If customer evaluation is available for the interaction, it is generally preferable to use it either as a customer satisfaction score 320, or as customer evaluation 336. As discussed above, customer satisfaction score is relevant for testing the performance when customer satisfaction categories are used. Another option for the input to categorization evaluation step 340 is external indication 336 such as user evaluation, in which a user, for example a person in charge of constructing or checking the categorization provides feedback. The feedback can be in the form of evaluating call category relevancy 332, or in the form of independently assigning categories to interactions which were categorized by the method. The method compares call category relevancy 332 with the feedback, and if the differences exceed a predetermined level, a corrective action is taken at categorization update step 344. At step 344 the method preferably detects automatically among all voice products 308, screen recordings 312, and third party data 316 common patterns for all interactions assigned to each category, and updates the criteria to look for these patterns. Step 344 is preferably performed by pattern recognition, clustering, or additional techniques. Alternatively, step 344 is performed by an automatic pattern detection step followed by supervision and correction by a human, such as an analyst, or by a human alone. The human preferably provides feedback about the system's performance or tunes the categorization. If at step 344 the method fails to generate criteria for the given categorization, new categories are optionally suggested or existing categories are optionally erased. The results of update step 344, comprising updated categories and criteria are integrated with or replace categories and criteria 328. Alternative external indications 336 to categorization evaluation step 340 include but are not limited to any one or more of the following: market analysis evaluation, customer behavioral analysis, agent behavioral analysis, business process optimization analysis, new business opportunities analysis, customer churn analysis, or agent attrition analysis.

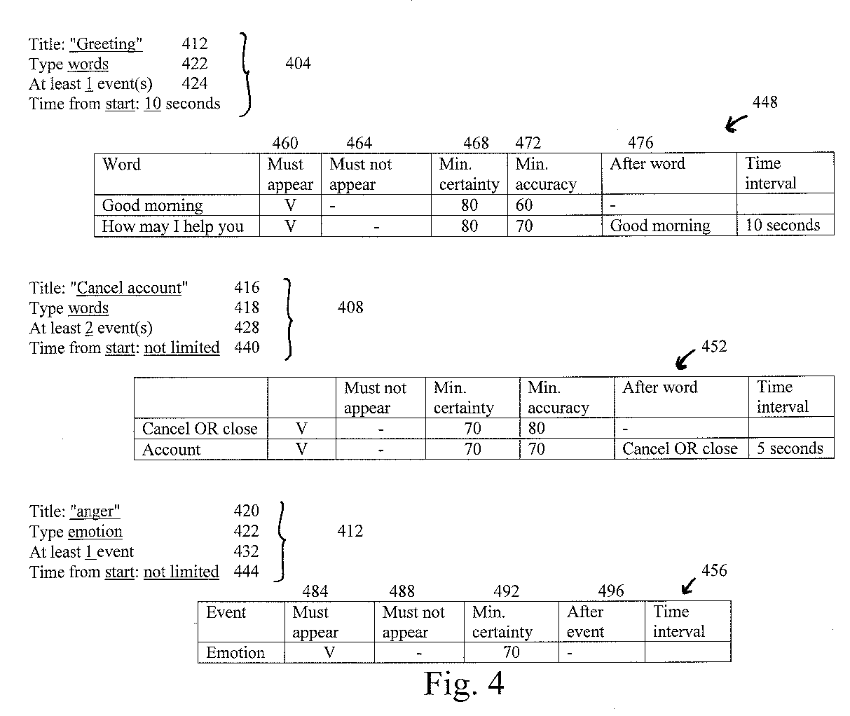

Referring now to FIG. 4, showing an exemplary format for defining criteria. FIG. 4 shows three examples, “greeting” example 404, “cancel account” criteria 408 and “anger” criteria 412. The criteria can be generated by a dedicated user interface, filling forms, generating an XML file or any other option. A user, who is preferably an evaluator, market analyst, customer care manager or any other person responsible for viewing analysis, a person in charge of defining categories and criteria, an employee of a third party member supplying services to the organization, or the like is defining the criteria. Each criterion is preferably assigned a name, such as “Greeting” 412, “Cancel Account” 416 or “Emotion” 420. A type is chosen for each criterion, such as “Words” 414 or 418, or “emotion” 422. Each criterion may contain one or more events of the chosen type, preferably in the form of a table, such as tables 448, 452, or 456. The criteria definition preferably denotes how many of the events in the table should occur for a criterion to be met, such as 424, 428, 432, and the time from the start or from the end of the interaction in which they should occur, such as indications 436, 440 and 444. The required details for the events in the tables depend upon the event type. For example for a word to be spotted the following words are required: a “must appear” indication 460, a “must not appear” indication 464, minimal certainty 468, minimal accuracy 472, a word this word should follow 476 and the time interval between the two words 480. Table 452 demonstrates a further mechanism in which an event is comprised of two words, wherein at least one of the words should appear. Example 412 relates to detecting emotion level, and comprises relevant fields, such as “must appear” 484, “must not appear 488, “after event” 492 and “Time interval” 496. Additional types of events criteria can may relate to, but are not limited to any one or more of the following: customer feedback in a DTMF form, transcription of free expression customer feedback, screen events captured on the display of the computer used by an organization member during the interaction, input from a third party system, or the like.

A category is defined by a collection of criteria that should be fulfilled for an interaction to be assigned to that category. The criteria are designated with relevant and/or/not relations, to indicate the requirement for two or more criteria, the absence of one or more criteria, the interchangeability of criteria, or the like.

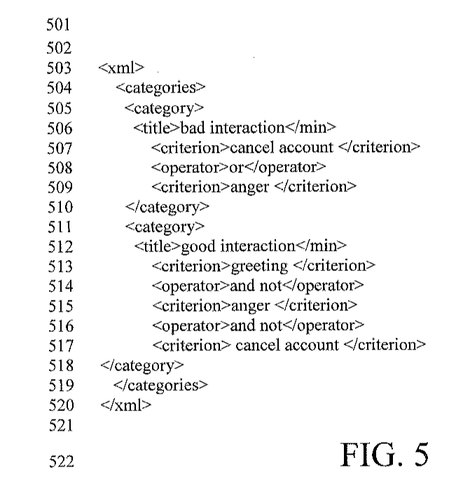

Referring now to FIG. 5, showing an XML listing of a collection of categories. The numbers below refer to the line numbers in FIG. 5. The listing comprises two categories starting at line 504. A first category starts at line 505, is titled “bad interaction” and is conditioned in the interaction meeting the criteria of “cancel account” at line 507, or the criterion of “anger” at line 509. The criteria are connected using an OR operator as in line 508, so if an interaction meets at least one of the two criteria, it is categorized as “bad interaction”. The second category, starting on line 511 is titled “good interaction”, and is conditioned in the interaction meeting the “greeting” criteria on line 513, and not meeting criterion “cancel account” or criterion “anger”. When two or more criteria are involved in a category, additional requirements can be posed, such as conditional analysis, i.e., performing a second analysis only if a condition is met for a first analysis, and particularly time-sequence related conditional analysis, for example time difference or relative order between the criteria. A category can relate to the whole interaction or to a part thereof, according to the detected criteria.

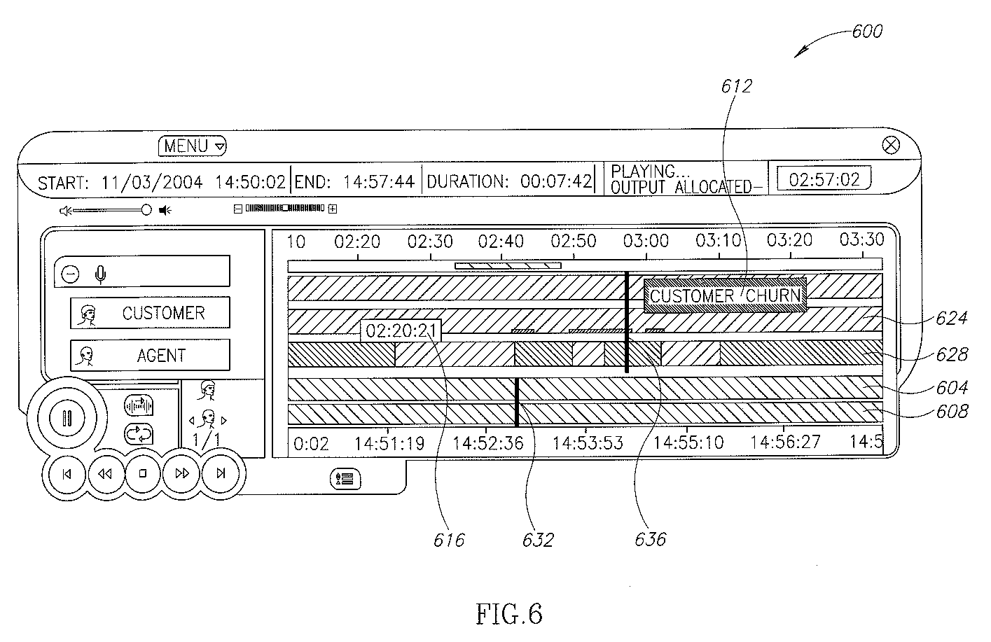

Referring now to FIG. 6 showing a playback application for a vocal interaction with category indication, in accordance with the disclosed invention. The playback display, generally referenced 600 shows a customer timeline 604 of the whole interaction, an agent timeline for the whole interaction 608, a customer timeline for the currently-reviewed part of the interaction 624 and an agent timeline for the currently-reviewed part of the interaction 628. However, the disclosed invention is not limited to an interaction between a customer and an agent, and can be used for any interaction, and FIG. 6 is intended for demonstration purposes only. The playback comprises indications for the time of the interaction currently being reviewed, being indication 632 for the whole interaction and 636 for the currently-reviewed part of the interaction. The playback further indicates a category associated with the interaction, such as customer churn indication 612. Customer churn indication 612 is shown on the relevant part of the interaction, being 03:10 minutes from the beginning of the interaction. Clicking on the indication optionally starts playing at the beginning of the time indication the categorization related to, or at the beginning of the interaction, if the categorization relates to the interaction as a whole. In addition to the playback indication, the categories and associated data, such as time within the indication, certainty or other factors are

FIGS. 4, 5, and 6 are exemplary only and do not imply an obligatory user interface or format for the criteria or for the categories. FIGS. 4, 5, and 6 are intended merely at demonstrating the principals of defining criteria for categories and showing a possible usage for the categorization.

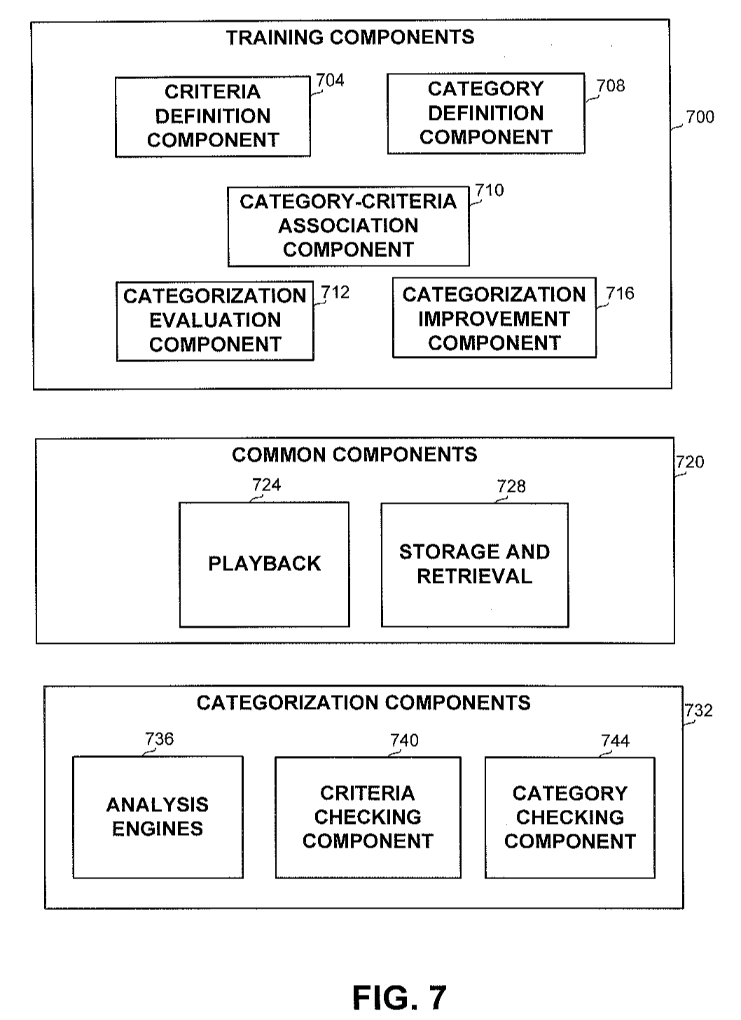

Referring now to FIG. 7, showing the main components in an apparatus designed to perform the method of the disclosed invention. The components of FIG. 7 provide a detailed description of components 138, 141, 142, 154, 158 and 146 of FIG. 1. The components of the disclosed apparatus are generally divided into training components 700, common components 720 and categorization components 732. Training components are used for defining, updating and enhancing the definition of criteria and categorization of the disclosed method, while categorization components 732 are active in carrying out the actual categorization of interactions in an on-going manner. Common components 720 are useful both for training and for the on-going work Training components 700 comprise a criteria definition component 704 for defining the criteria according to which interactions will be assigned to categories. The definition can utilize a user interface such as shown in FIG. 4, or any other. The definition preferably relates to all data types available as input, including spotted words, free search in a transcribed text, phonetic search, emotion analysis, call flow analysis, or similar. When defining category criteria, multi-phase conditional analysis rules can be defined for utilizing engines in an optimized manner. For example, a fast and speaker-independent phonetic search algorithm can be employed, followed by speech to text analysis which is performed only for interactions in which the phonetic engine detected certain words or phrases, thus increasing the utilization of analysis resources. The multi-phase analysis can be used in various engine and input combinations such as speech recognition, speaker recognition, emotion analysis, call flow analysis, or analyzing information items such as screen data, screen events, CTI data, user feedback, business data, third party external input, or the like. Category definition component 708 is used for defining one or more categories. The categories can be sub-categories or super-categories of existing categories, complementary to existing categories or unrelated to existing ones. For each category, a user defines the criteria combination that should occur for an interaction to be assigned to that category. Categorization-criteria association step 710 enables the association of one or more criteria with a category. For associating multiple criteria with a category, relations such as “and”, “or”, “not” or a combination thereof are used, optionally with temporal conditions and/or with other conditions. Exemplary conditions can be “part of”, “not part of”, “includes”, “not includes”, “includes at-least”, “includes none of”, “includes some of”, or any of the above with minimal or maximal time duration. Training component 700 further comprise a categorization evaluation component 712. Categorization evaluation component 712 receives categorized interactions and their categorization as assigned by the system, and control indication, such as a customer satisfaction score, external categorization of the same interactions, or grades for the system categorization. Categorization evaluation component 712 then checks the matching between the system categorization and the externally provided categorization, or the performance of the system as reflected by the grades. If the performance or the matching is below a predetermined threshold, categorization improvement component 716 is used. Categorization improvement component 716 provides a user with the option to review the system categorization and the associated criteria, and update the criteria definition or the category definition. For example, if too few calls are categorized under “customer churn: category, the spotted words may not include some of the words used by churning customers. Alternatively, if an external categorization is available for all interactions, the system can gather all data related to an interaction, such as all spotted words, full transcription, emotion analysis, screen events, and others, and try to find characteristics which are common to all calls assigned to a specific category. The common characteristics can be found using methods such as clustering, semi-clustering, K-means clustering or the like. A combination of automated and manual method can be used as well, wherein a human provides an initial set of categorizations and criteria, and the system enhances the results, or vice versa. The step of automatically determining common characteristics can also be used in step 712 and 716, wherein a user defines a set of categories and assigns interactions to each category, and the system finds the relevant criteria for each category, based on the assigned interactions. Categorization components 732 include analysis engines 736, such as word spotting engine, transcription engine, emotion analysis engine, call flow analysis engine, screen events engine and others. Analysis engines 736 receive an interaction or a part thereof, such as the audio part of a video interaction, and extract the relevant data. Criteria checking component 740 receives the data extracted by analysis engines 736 and checks which criteria occurs in an interaction, according to the extracted data and to the criteria definitions, and category checking component 744 determines a score of assigning the interaction or a part thereof to one or more categories, according to the met criteria, indicated by criteria checking component 740. In an alternative embodiment, criteria checking component 740 and category checking component 744 can consist of a single component, which checks the criteria associated with each category during the category check, rather than checking all criteria first. Common components 720 comprise playback component 724 for letting a user review an interaction. Playback component 724 may consist of a number of components, each related to a specific interaction type. Thus, the playback shown in FIG. 4 can be used for voice interactions, a video player can be used for video interactions, and similarly for other types. Common components 720 further comprise storage and retrieval components 728 for storing and retrieving data related to the interactions such as the products of analysis engines 736 or other data, criteria and category definitions and categorization information.

The disclosed method and apparatus present a preferred implementation for categorizing interactions into one or more of a set of predetermined categories, according to a set of criteria. The method uses multi-dimensional analysis, such as content base analysis to extract as much information as possible from the interactions and accompanying data. The disclosed method and apparatus are versatile and can be implemented for any type of interaction and any desired criteria. Analysis engines that will be developed in the future can be added to the current invention and new criteria and categories can be designed to accommodate their results, or existing criteria and categories can be updated for that end. The collected information or classification can be used for purposes such as follow-up of interactions assigned to problematic categories, agent evaluation, product evaluation, customer churn analysis, generating an alert or any type of report.

It will be appreciated by a person of ordinary skill in the art that the disclosed method and apparatus are exemplary only and that other divisions to steps, components or interconnections between steps and components can be designed without departing from the spirit of the disclosed invention.

The apparatus description is meant to encompass components for carrying out all steps of the disclosed methods. The apparatus may comprise various computer readable media having suitable software thereon, for example, CD-ROM DVD, disk, diskette or flash RAM.

It will be appreciated by persons skilled in the art that the present invention is not limited to what has been particularly shown and described hereinabove. Rather the scope of the present invention is defined only by the claims which follow.

1. A method for automated categorization of an at least one interaction, the method comprising:
a criteria definition step for defining an at least one criterion associated with an at least one information item;
a category definition step for defining an at least one category associated with an at least one aspect of the organization;
an association step for associating the at least one criterion with the at least one category;
a receiving step for receiving an at least one information item related to the at least one interaction;
a criteria checking step for determining whether the at least one criterion is met for the at least one interaction; and
a categorization step for determining an interaction category relevancy for an at least one part of the at least one interaction and the at least one category.

2. The method of claim 1 further comprising a capturing step for capturing the at least one interaction.

3. The method of claim 1 wherein the at least one interaction comprises a vocal component.

4. The method of claim 1 further comprising an interaction analysis step for extracting the at least one information item from the at least one interaction.

5. The method of claim 4 wherein the analysis step comprises one or more analyses selected from the group consisting of: word spotting; transcription;
emotion detection; call flow analysis; or analyzing an at least one relevant information item.

6. The method of claim 5 wherein the at least one relevant information item is selected from the group consisting of: customer satisfaction score; screen event; third party system data; Computer-Telephony-Integration data; Interactive Voice Response data; Business data; video data; surveys; customer input; customer feedback; or a combination thereof.

7. The method of claim 6 wherein the analysis step is multi-phase conditional analysis between at least two analyses.

8. The method of claim 7 wherein the analysis is time-sequence related.

9. The method of claim 1 wherein the at least one information item is selected from the group consisting of: customer satisfaction score; screen event; third party system data; Computer-Telephony-Integration data; Interactive Voice Response data; Business data; video data; surveys; customer input; customer feedback; or a combination thereof.

10. The method of claim 1 wherein at least one criterion is a temporal criterion.

11. The method of claim 1 further comprising a notification step.

12. The method of claim 11 wherein the notification step comprises any one or more of the group consisting of: generating a report; firing an alert; sending a mail; sending an e-mail; sending a fax; sending a text message; sending a multi-media message; or updating a predictive dialer.

13. The method of claim 1 further comprising a categorization evaluation step for evaluating a performance factor associated with the categorization step according to an at least one external indication.

14. The method of claim 13 wherein the external indication is any one or more or the group consisting of: customer satisfaction score; user evaluation; market analysis evaluation; customer behavioral analysis; agent behavioral analysis; business process optimization analysis; new business opportunities analysis; customer churn analysis; or agent attrition analysis.

15. The method of claim 1 wherein the criteria relates to spotting at least first predetermined number of words out of a predetermined word list.

16. The method of claim 1 wherein the at least one category is associated with at least two criteria.

17. The method of claim 16 wherein the at least two criteria are connected through an at least one operator.

18. The method of claim 17 wherein the at least one operator is selected from the group consisting of: “and”; “or”; or “not”.

19. The method of claim 1 wherein the interaction category relevancy is a prediction of customer satisfaction score.

20. The method of claim 1 wherein the category definition step is performed manually.

21. The method of claim 1 wherein the category definition step is performed automatically.

22. The method of claim 21 wherein the category definition step uses clustering.

23. The method of claim 1 wherein the category definition step is semi-automated.

24. The method of claim 1 further comprising a categorization update step.

25. The method of claim 24 wherein the categorization update step is performed by providing feedback.

26. The method of claim 24 wherein the categorization update step is performed by tuning the at least one category.

27. The method of claim 1 wherein the at least one category is constructed using a self learning process.

28. An apparatus for automated categorization of an at least one interaction between a member of an organization and a second party, the apparatus comprising:
a criteria definition component for defining an at least one criterion associated with an at least one information item;
a category definition component for defining an at least one category associated with an at least one aspect of the organization;
an association component for associating the at least one criterion with the at least one category;
a criteria checking component for checking according to an at least one information item associated with the at least one interaction whether the at least one criterion is met for the at least one interaction; and
a category checking component for determining an at least one score for assigning an at least one part of the at least one interaction to the at least one category.

29. The apparatus of claim 28 further comprising an at least one analysis engine for extracting the at least one information item.

30. The apparatus of claim 29 wherein the at least one analysis engine is selected from the group consisting of: word spotting; transcription; emotion detection; call flow analysis, or analyzing an at least one relevant information item.

31. The apparatus of claim 28 further comprising a playback component for reviewing the at least one interaction and an at least one category indication.

32. The apparatus of claim 28 further comprising a storage and retrieval component for storing the at least one score.

33. The apparatus of claim 28 further comprising a storage and retrieval component for retrieving necessary data sources.

34. The apparatus of claim 28 further comprising a categorization evaluating component for evaluating an at least one performance factor associated with the at least one score.

35. The apparatus of claim 28 further comprising a categorization improvement component for enhancing the at least one category or the at least one criterion.

36. A computer readable storage medium containing a set of instructions for a general purpose computer, the set of instructions comprising:
a criteria definition component for defining an at least one criterion associated with an at least one information item;
a category definition component for defining an at least one category associated with an at least one aspect of the organization;
an association component for associating the at least one criterion with the at least one category;
a criteria checking component for checking according to an at least one information item associated with the at least one interaction whether the at least one criterion is met for the at least one interaction; and
a category checking component for determining an at least one score for assigning an at least one part of the at least one interaction to the at least one category.
